(19) United States
(12) Patent Application Publication
(10) Pub. No.: US 2012/0047362 A1
(43) Pub. Date: Feb. 23, 2012

(54) PORTABLE ELECTRONIC FULL SCREEN SYSTEM EQUIPPED WITH COMPUTER PROCESSING FUNCTION

(76) Inventor: Qing-Wen YANG, Taichung City (TW)

(21) Appl. No.: 12/859,908

(22) Filed: Aug. 20, 2010

(51) Int. Cl. G09G 5/00; H04L 9/00

(52) U.S. Cl. 713/153; 345/1.3

(57) ABSTRACT

A portable electronic full screen system equipped with comprehensive computer processing function includes a portable electronic full screen module and a remote host. The portable electronic full screen module is linked to the remote host through a public network to get comprehensive processing power to perform application processing. Processed data is presented in a multimedia fashion on the portable electronic full screen module. Compared with conventional mobile devices such as E-book, iPAD, SmartBook, Netbook and the like, the portable electronic full screen module has a powerful computer processing capability and has a screen of the same size of the conventional mobile devices without changing too much of hardware structure, and maintains features of the mobile devices of thin and light, energy-saving, lower cost and longer power life.

### FIELD OF THE INVENTION

The present invention relates to a portable electronic full screen system and particularly to a portable electronic full screen system equipped with computer processing function.

### BACKGROUND OF THE INVENTION

To make mobile devices that have a large screen, thin and light, consume less power and can be produced at lower costs to equip with notebook computer capability, or notebook computers to equip with features of mobile devices such as thin and light, energy-saving and lower costs are development directions heavily pursued by the industry in recent years. However, the mobile device equipped with a large screen and also is thin and light and lower cost and consumes less power generally cannot provide computer function to support the commonly adopted platforms of Windows XP, Windows 7 or MAC. The notebook computer capable of executing a large operation system such as Windows XP, Windows 7 or MAC requires a huge amount of resource, thus cannot be made thin and light at a lower cost and energy-saving like the mobile device equipped with a large screen such as iPAD or E-book. These products can be grouped in two types: 1. Mobile devices that are power-saving and portable to facilitate carrying, but not equipped with full personal computer functions such as large storage, PC MS Office, PC Outlook or PC compatibility; 2. Mobile devices compatible with personal computer but are heavier, bulkier, large power-consuming and insufficient power life. The characteristics of these two types of products contradict against each other. How to provide a simple and effective solution that maintains the characteristics of a large screen mobile device of thin and light and power-saving, and also are fully compatible with personal computer is a thorny issue not yet overcome to date. To meet the aforesaid user's requirements, huge amount of investments and efforts have to be constantly devoted to innovation of hardware manufacturing process to make large screen mobile devices thin and light with a longer power life and also compatible with the personal computer.

Moreover, the conventional mobile devices not supporting PC MS Windows or Apple MAC platform mostly do not have a common user and operation interface. That difference in various products requires users more time in understanding and learning, and creates an extra burden to the unskillful users. Nowadays MS Windows or Apple MAC personal computers are the most popular and well-accepted information devices, they need least amount of education and training, and minimum marketing cost, market acceptance is highest and promotion is easiest.

### SUMMARY OF THE INVENTION

The primary object of the present invention is to provide a portable electronic full screen system equipped with comprehensive computer processing function that also includes features such as a large screen, portable, longer power life, thin and light, energy-saving and lower cost.

Another object of the present invention is to provide a portable electronic full screen system with a transmission and user interface compatible with the personal computer of PC MS Windows or Apple MAC.

To achieve the foregoing objects the portable electronic full screen system according to the present invention includes a portable electronic full screen module and a remote host. The portable electronic full screen module includes a human machine control unit, a first communication unit connecting to the human machine control unit, a full screen simulation unit connecting to the first communication unit, and an output unit connecting to the full screen simulation unit. The human machine control unit receives a control command which is sent through the first communication unit through a public network to the remote host. The remote host receives the control command and performs a corresponding process, then sends processed data through the public network back to the portable electronic full screen module. The first communication unit receives the processed data which is further processed by the full screen simulation unit for a full screen simulation of signals, then is sent to the output unit which outputs a multimedia information.

As described above, the present invention enables the portable electronic full screen simulation module which is linked to the remote host via the public network to have comprehensive processing ability in applications. The processed data is delivered through the output unit in a multimedia information fashion and presented on the portable electronic full screen module. Although the portable electronic full screen module is simpler in structure, by linking to the public network it can perform more complicated processes. Moreover, it does not need too many hardware elements and maintains the feature of longer power life for portable device, and also keeps the advantages of thin and light and provides powerful processing ability. In addition, the full screen simulation unit can execute a full screen simulation similar to high definition to support system operation of the remote host.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a schematic chart showing the process procedure of an embodiment of the present invention.

### DETAILED DESCRIPTION OF THE PREFERRED EMBODIMENT

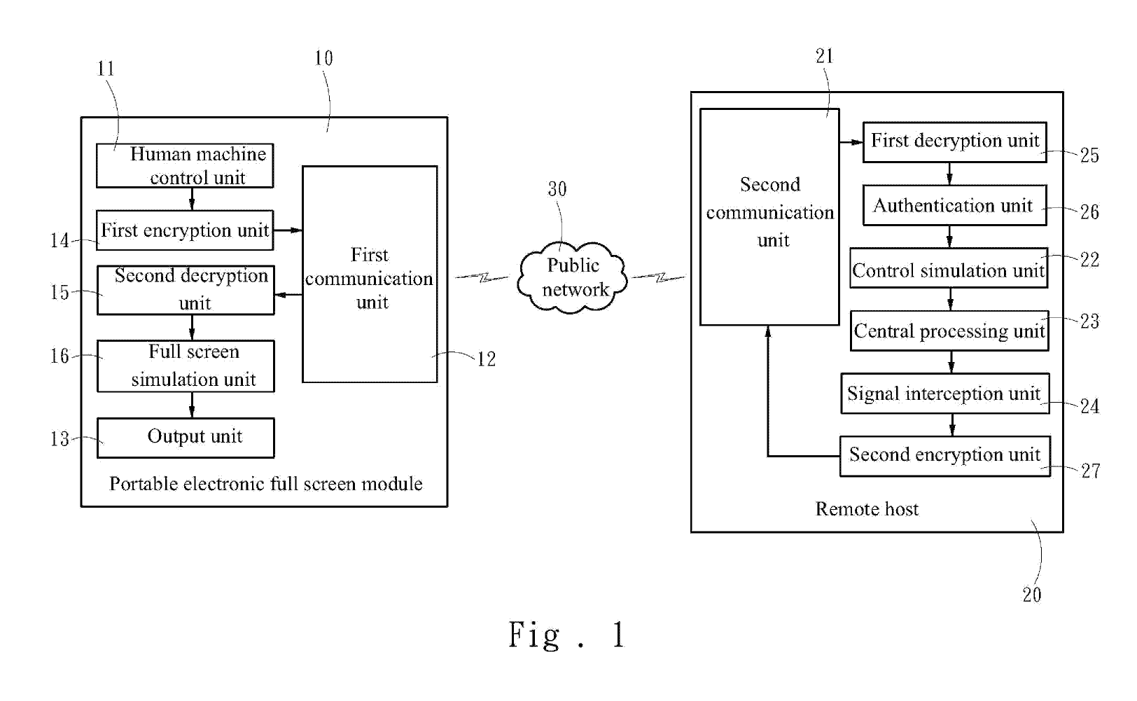

Please refer to FIG. 1 for the process procedure of an embodiment of the invention. The present invention provides a portable electronic full screen system equipped with computer processing function, which comprises a portable electronic full screen module 10 and a remote host 20. The portable electronic full screen module 10 includes a human machine control unit 11, a first communication unit 12 connecting to the human machine control unit 11, a full screen simulation unit 16 connecting to the first communication unit 12 and an output unit 13 connecting to the full screen simulation unit 16. The human machine control unit 11 receives a control command which is sent through the first communication unit 12 via a public network 30 to the remote host 20. The human machine control unit 11 is selectively a keyboard, a mouse, a touch control interface, a voice control interface or combinations thereof that allows a user to control input and converts the input to the control command.

The remote host 20 receives the control command and performs a corresponding process, then sends processed data through the public network 30 back to the portable electronic full screen module 10.

The first communication unit 12 receives the processed data which is further processed by the full screen simulation unit 16 for full screen simulation of signals, then is sent to the output unit 13 which outputs a multimedia information. The multimedia information can be voice signals, video signals, screen pictures or combinations thereof. The full screen simulation unit 16 performs the full screen simulation of the pictures output from the remote host 20 to enhance application usability. The public network 30 is connected to the first communication unit 12 and a second communication unit 21. In this embodiment the connection is a wireless network connection, such as Wi-Fi, WiMAX, mobile communication network, Bluetooth communication or infrared communication or the like.

In this embodiment the remote host 20 includes the second communication unit 21 to receive the control command through the public network 30, a control simulation unit 22 connecting to the second communication unit 21, a central processing unit 23 connecting to the control simulation unit 22 and a signal interception unit 24 connecting to the central processing unit 23 and second communication unit 21. The control simulation unit 22 receives the control command and simulates the control interface of the human machine control unit 11 to perform a corresponding control to the central processing unit 23. The signal interception unit 24 intercepts the processed data processed by the central processing unit 23 and sends the processed data to the public network 30 through the second communication unit 21.

Furthermore, the portable electronic full screen module 10 may also be equipped with encryption security function for transmitting the control command through the public network 30 to the remote host 20. The portable electronic full screen module 10 may include a first encryption unit 14, and the remote host 20 may include a first decryption unit 25 corresponding to the first encryption unit 14. The human machine control unit 11 is connected to the first communication unit 12 through the first encryption unit 14 which encrypts the control command before it is sent out. The second communication unit 21 is connected to the control simulation unit 22 through the first decryption unit 25 which decrypts the control command before sending to the control simulation unit 22.

In order to confirm user's identification and use authority, the remote host 20 further includes an authentication unit 26 to bridge the first decryption unit 25 and control simulation unit 22 to confirm user's identification. After user's identification is confirmed to be correct, the control command is sent to the control simulation unit 22.

Similarly, to enhance encryption and security of the processed data sent from the remote host 20 through the public network 30 to the portable electronic full screen module 10, the remote host 20 includes a second encryption unit 27 and the portable electronic full screen module 10 includes a second decryption unit 15 corresponding to the second encryption unit 27. The signal interception unit 24 is connected to the second communication unit 21 through the second encryption unit 27 which encrypts the processed data before it is sent out. The first communication unit 12 is connected to the output unit 13 through the second decryption unit 15 which decrypts the encrypted processed data before it is sent to the output unit 13.

The portable electronic full screen module 10 may also be attached to a large screen mobile device (not shown in the drawing) which may be an E-book, Smart book, or Net book. A great portion of functions of the portable electronic full screen module 10 are provided by the remote host 20 through the public network 30, hence hardware requirement can be greatly reduced to meet other requirements such as thin and light, energy-saving and low cost. On the other hand, the conventional non-cell phone large screen mobile device (such as E-book) does not have capability to support MS Windows or Apple MAC platform, hence, in the case of E-book, can only provide reading function; to perform media play requires a hard disk of huge capacity to store files, and also needs chip sets of image processing capability and audio processing capability, as a result, the size increases and the cost is higher, and consumer's purchase desire is lower. Through the portable electronic full screen module 10 of the present invention, the remote host 20 can be linked to the portable electronic full screen module 10 through the human machine control unit 11 and first communication unit 12 via the public network 30, and a corresponding control simulation can be performed through the control simulation unit 22 resided on the remote host 20, and the central processing unit 23 in the remote host 20 can perform corresponding computer processes, such as document process, images and audio process of media playing and the like. Finally the process result can be sent back to the portable electronic full screen module 10 and image and audio can be output through the output unit 13. Usability improves, computer function is enhanced on the E-book to the PC level, most important, the cost does not increase significantly, and consumer's purchase desire can be boosted.

As a conclusion, the present invention provides the portable electronic full screen module 10 and remote host 20 that are linked via the public network 30, hence the portable electronic full screen module 10 can get more comprehensive processing ability through the remote host 20 to perform applications; and the processed data can be output in a multimedia information fashion through the output unit 13. Therefore, some power consuming tasks can be transferred to the remote host 20 for processing, and some existing devices (such as 2.5-inch hard disk or the like) can be dispensed with to reduce the weight and power consumption of the mobile device. Format support issue of the conventional mobile devices (such as E-book) can be standardized through image and audio signal conversion at the remote host 20 and sent back to the portable electronic full screen module 10 through the network without too much hardware. The mobile device can be used for a longer duration and also maintain the advantages of thin and light, lower cost and powerful performance. In addition, through the full screen simulation unit 16 a full screen simulation similar to high definition can be performed to support system operation of the remote host 20.

What is claimed is:

1. A portable electronic full screen system equipped with computer processing function, comprising:
a portable electronic full screen module which includes a human machine control unit, a first communication unit connecting to the human machine control unit, a full screen simulation unit connecting to the first communication unit and an output unit connecting to the full screen simulation unit, the human machine control unit receiving a control command which is sent through the first communication unit to a public network; and
a remote host which receives the control command through the public network and performs a corresponding process and sends processed data through the public network back to the portable electronic full screen module after performing the corresponding process;
wherein the first communication unit receives the processed data which is processed by the full screen simulation unit for a full screen simulation of signals then be sent to the output device which outputs a multimedia information.

2. The portable electronic full screen system of claim 1, wherein the remote host comprises a second communication unit to receive the control command through the public network, a control simulation unit connecting to the second communication unit, a central processing unit connecting to the control simulation unit, and a signal interception unit bridging the central processing unit and the second communication unit; the control simulation unit performing a corresponding operation to the central processing unit based on the received control command, the signal interception unit intercepting the processed data processed by the central processing unit and sending the processed data to the public network through the second communication unit.

3. The portable electronic full screen system of claim 2, wherein the portable electronic full screen module includes a first encryption unit, the remote host including a first decryption unit corresponding to the first encryption unit, the human machine control unit being connected to the first communication unit through the first encryption unit which encrypts the control command before sending out, the second communication unit being connected to the control simulation unit through the first decryption unit which decrypts the control command before sending to the control simulation unit.

4. The portable electronic full screen system of claim 3, wherein the remote host further includes an authentication unit which bridges the first decryption unit and the control simulation unit to confirm user's identification acceptable before the control command is sent to the control simulation unit.

5. The portable electronic full screen system of claim 2, wherein the remote host includes a second encryption unit and the portable electronic full screen module includes a second decryption unit corresponding to the second encryption unit, the signal interception unit being connected to the second communication unit through the second encryption unit which encrypts the processed data and sends the encrypted data out, the first communication unit being connected to the output unit through the second decryption unit which decrypts the encrypted processed data and sends the decrypted data to the output unit.

6. The portable electronic full screen system of claim 2, wherein the public network is linked to the first communication unit and the second communication unit selectively through a wired network or a wireless network.

7. The portable electronic full screen system of claim 2, wherein the control simulation unit simulates a control interface of the human machine control unit to perform a corresponding control to the central processing unit.

8. The portable electronic full screen system of claim 1, wherein the human machine control unit is selected from the group consisting of a keyboard, a mouse, a touch control interface, a voice control interface and combinations thereof.

9. The portable electronic full screen system of claim 1, wherein the multimedia information is selected from the group consisting of voice signals, video signals, screen pictures and combinations thereof.

10. The portable electronic full screen system of claim 1, wherein the portable electronic full screen module is attached to a large screen mobile device which is selected from the group consisting of an E-book, a Smart book and a Net book.
